(19) United States
(12) Patent Application Publication
(10) Pub. No.: US 2018/0188675 A1
(43) Pub. Date: Jul. 5, 2018

(54) SHEET POST-PROCESSING APPARATUS AND SENSOR DETERIORATION DETECTION METHOD

(71) Applicants: KABUSHIKI KAISHA TOSHIBA, Tokyo (JP); TOSHIBA TEC KABUSHIKI KAISHA, Tokyo (JP)

(72) Inventor: Yosuke KATAYAMA, Mishima Shizuoka (JP)

(21) Appl. No.: 15/394,304

(22) Filed: Dec. 29, 2016

(51) Int. Cl. G03G 15/00

(52) U.S. Cl. CPC G03G 15/5062

(57) ABSTRACT

A sheet post-processing apparatus according to an embodiment includes a sensor, a detection unit, a retrieval unit, and an output unit. The detection unit detects a deterioration of the sensor based on an output value of the sensor. When the deterioration of the sensor is detected, the retrieval unit retrieves an available time indicating a future available time of the sensor. The retrieved available time corresponds to the output value of the sensor. The output unit outputs the retrieved available time.

### FIELD

Embodiments described herein relate generally to a sheet post-processing apparatus and a sensor deterioration detection method.

### BACKGROUND

An image forming apparatus may include a post-processing apparatus that performs sheet post-processing such as punching (drilling), stapling, and paper folding. An analog sensor for detecting a sheet transported at a high speed is provided in the post-processing apparatus. For example, a light sensor including a light emitting unit and a light receiving unit is used in the analog sensor. The light sensor performs sheet detection by detecting that light is blocked between the light emitting unit and the light receiving unit by the transported sheet. In such a light sensor, reduction of the amount of emitted light and reduction of the amount of received light occur due to deterioration over time. When such deterioration occurs on a sheet detection sensor, sheet detection is not correctly performed such that it becomes a cause of failure.

### BRIEF DESCRIPTION OF THE DRAWINGS

FIG. 1 is a perspective view illustrating an image forming apparatus and a sheet post-processing apparatus according to an embodiment.

FIG. 2 is a functional block diagram illustrating an example configuration of a sheet detection unit in the sheet post-processing apparatus.

FIG. 3 is an example table in which a relationship between the amount of emitted light and the amount of received light stored in a storage unit is indicated.

FIG. 4 is an example table in which the relationship between the amount of received light and the available time is stored.

FIG. 5 is a flowchart illustrating an example sequence of operations of the sheet post-processing apparatus according to the embodiment.

### DETAILED DESCRIPTION

A sheet post-processing apparatus according to an embodiment includes a sensor, a detection unit, a retrieval unit, and an output unit. The detection unit detects a deterioration of the sensor based on an output value of the sensor. When the deterioration of the sensor is detected, the retrieval unit retrieves an available time indicating a future available time of the sensor. The retrieved available time corresponds to the output value of the sensor. The output unit outputs the retrieved available time.

Hereinafter, the sheet post-processing apparatus and a sensor deterioration detection method according to the embodiment will be described with reference to the drawings. First, the sheet post-processing apparatus and the image forming apparatus of outputting a sheet after image formation with respect to the sheet post-processing apparatus will be described.

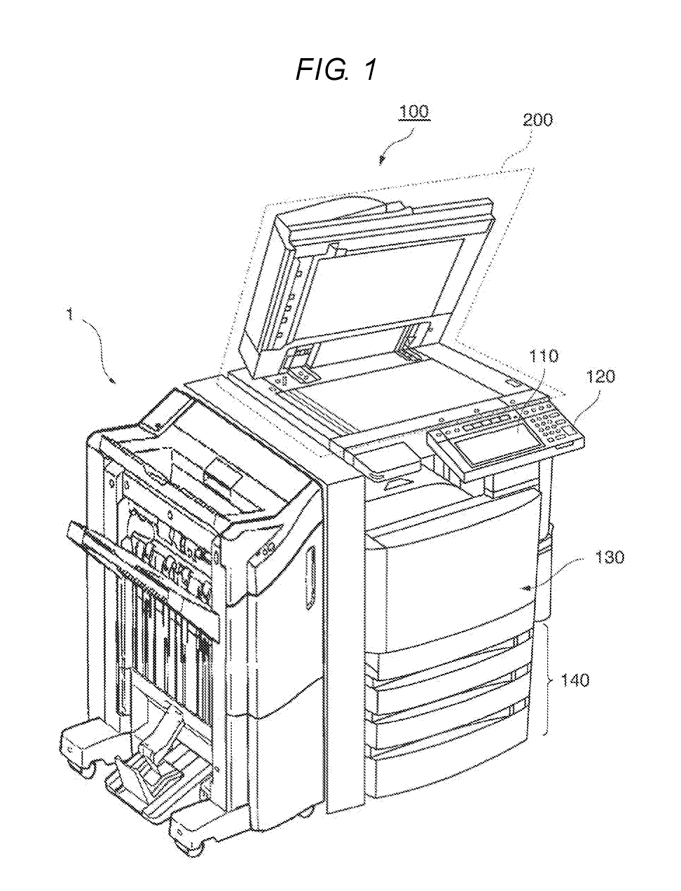

FIG. 1 is an perspective view illustrating an overall configuration of an image forming apparatus 100 and a sheet post-processing apparatus 1 according to the embodiment. For example, the image forming apparatus 100 may be a multifunction peripheral (MFP). The image forming apparatus 100 includes a display 110, a control panel 120, a printer unit 130, a sheet accommodation unit 140, and an image read unit 200. The printer unit 130 of the image forming apparatus 100 maybe an apparatus that fixes a toner image. Alternatively, the image forming apparatus 100 may be an ink jet type apparatus.

The image forming apparatus 100 forms an image on the sheet by using recording agent such as toner. For example, the sheet may be a plain sheet or a label sheet. The sheet may be any sheet as long as the image forming apparatus 100 can form an image on a front surface thereof.

The display 110 is an image display device such as a liquid crystal display (LCD) or an organic electro luminescence (EL) display. The display 110 displays various items of information regarding the image forming apparatus 100.

The control panel 120 includes a plurality of buttons. The control panel 120 receives input of an operation from a user. The control panel 120 outputs a signal in accordance with the operation input by the user to a control unit of the image forming apparatus 100. The display 110 and the control panel 120 may be configured as an integrated touch panel.

The printer unit 130 forms an image on the sheet based on image information received through a communication interface or image information generated by the image read unit 200. For example, the printer unit 130 forms an image by a process which will be described below. An image forming unit of the printer unit 130 forms an electrostatic latent image on a photoreceptor drum based on the image information. The image forming unit of the printer unit 130 forms a visible image by applying the recording agent to the electrostatic latent image. A specific example of the recording agent is toner. A transfer unit of the printer unit 130 transfers the visible image to the sheet. A fixing unit of the printer unit 130 performs heating and pressing with respect to the sheet, and fixes the visible image on the sheet.

A sheet on which an image is formed may be accommodated in the sheet accommodation unit 140, or it maybe a sheet which is manually supplied. The sheet accommodation unit 140 accommodates a sheet used for image formation in the printer unit 130.

The image read unit 200 reads image information of a read target as brightness and darkness of light. The image read unit 200 records the read image information. The recorded image information may be transmitted to other information processing apparatus through a network. The recorded image information may be formed as an image on the sheet by the printer unit 130.

The sheet post-processing apparatus 1 performs post-processing on sheets output from the image forming apparatus 100 after image formation. The post-processing performs punching, stapling, paper folding, or the like with respect to the sheet.

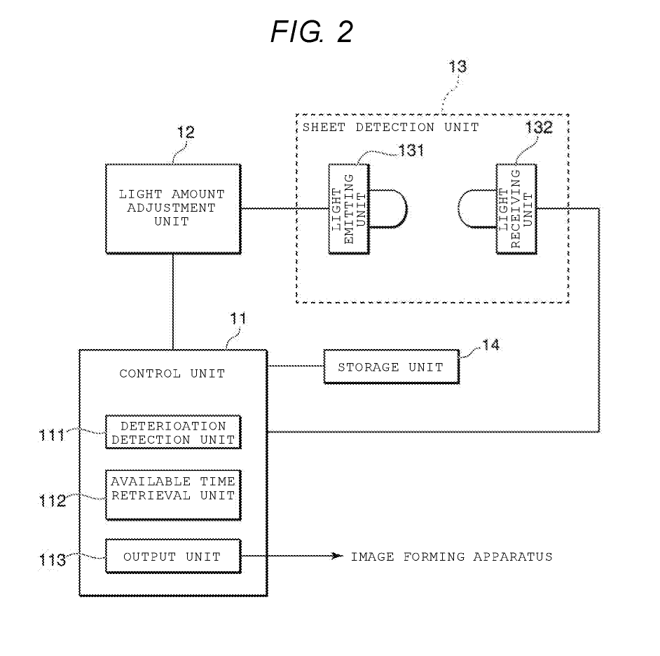

Next, with reference to FIG. 2, the sheet post-processing apparatus 1 that performs the post-processing with respect to the sheets output from the image forming apparatus 100 will be described. FIG. 2 is a functional block diagram illustrating an example configuration of a sheet detection unit of the sheet post-processing apparatus 1. The sheet post-processing apparatus 1 includes a control unit 11, a light amount adjustment unit 12, a sheet detection unit 13, and a storage unit 14. The sheet detection unit 13 includes a light emitting unit 131 and a light receiving unit 132.

The control unit 11 collectively controls operations of the sheet post-processing apparatus 1. The control unit 11 includes a deterioration detection unit 111 (detection unit). The deterioration detection unit 111 detects deterioration of a sensor included in the sheet post-processing apparatus 1. The sheet detection unit 13 is an example of the sensor. In this case, the deterioration detection unit 111 detects the deterioration of the light emitting unit 131 and the light receiving unit 132. In addition, the control unit 11 includes an available time retrieval unit 112 (retrieval unit) that retrieves an available time of the sheet detection unit 13. In addition, the control unit 11 includes an output unit 113 that outputs the retrieved available time to the image forming apparatus 100 or other apparatus. The light amount adjustment unit 12 adjusts the amount of light emitted from the light emitting unit 131. In one embodiment, the control unit 11 is a processor that is programmed to carry out the functions of the deterioration detection unit 111, the available time retrieval unit 112, and the output unit 113. In another embodiment, the control unit 11 is a hardware controller, e.g., an application specific integrated circuit (ASIC) and field programmable gate array (FPGA), that is configured to carry out the functions of the deterioration detection unit 111, the available time retrieval unit 112, and the output unit 113.

The sheet detection unit 13 performs detection of the sheet transported from the image forming apparatus 100. The light emitting unit 131 performs light emission based on a voltage value or a current value adjusted by the light amount adjustment unit 12. For example, the light emitting unit 131 includes a light emitting diode. The light receiving unit 132 receives the light emitted from the light emitting unit 131. For example, the light receiving unit 132 includes a photodiode. The light receiving unit 132 outputs a voltage value in accordance with the amount of received light to the control unit 11. The sheet detection unit 13 performs the sheet detection by detecting that light is blocked between the light emitting unit 131 and the light receiving unit 132 by the transported sheet. The control unit 11 determines whether or not the amount of received light in accordance with the amount of emitted light immediately after the power source is turned ON is reduced, equal to, or greater than a predetermined value.

The storage unit 14 includes a non-volatile memory, and stores the amount of emitted light and the amount of received light.

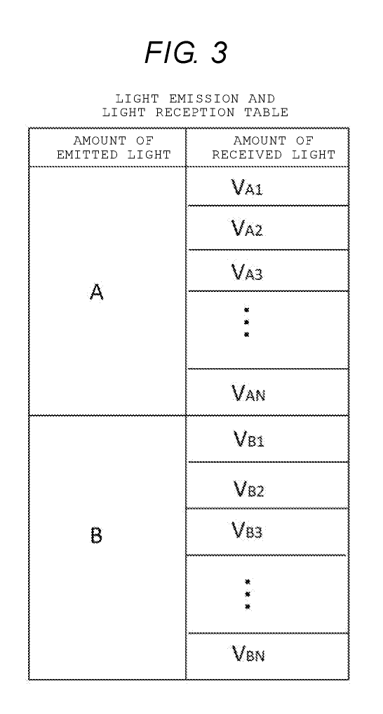

Next, with reference to FIG. 3, a table (light emission and light reception table) in which a relationship between the amount of emitted light and the amount of received light is stored will be described. FIG. 3 is an example light emission and light reception table in which the relationship between the amount of emitted light and the amount of received light is stored. In the example illustrated in FIG. 3, there are two types of the amounts of emitted light A and B. The amounts of emitted light A and B satisfy a relationship of A<B. That is, the amount of emitted light A is the amount of emitted light of an initial value such as a predetermined voltage value or current value. The amount of emitted light B is used for preventing erroneous detection by setting the amount of emitted light to a value greater than an initial value, when the deterioration occurs in the sheet detection unit 13.

The amount of received light is a voltage value read by the control unit 11. In FIG. 3, V_{A1} to V_{AN} are stored as the amount of received light when the amount of emitted light A is adopted. The light emission and light reception table, as an area for storing the amount of received light, has a structure in which new values are stored by predetermined number of times. That is, N (predetermined natural number) different amounts of received light are always stored. The amount of emitted light B is also the same as that of the amount of emitted light A.

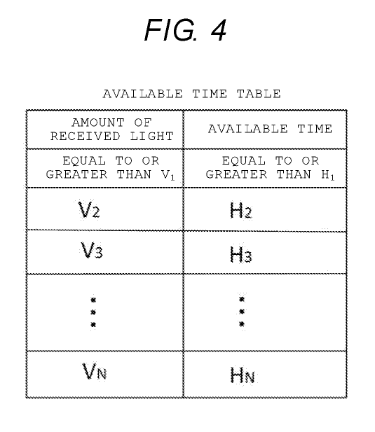

Next, with reference to FIG. 4, the available time table stored in advance in the storage unit 14 will be described. FIG. 4 is an example available time table. Voltage values (V₁ to V_{N}) that are amounts of received light and available times when the respective amounts of received light are adopted are associated with each other in the available time table. The available time indicates a future available time of the light emitting unit 131 and the light receiving unit 132, i.e., a future available time of the sheet detection unit 13. In FIG. 4, values equal to or greater than an available time H₁ are associated with values equal to or greater than the amount of received light V₁. That is, if the amount of received light is equal to or greater than V₁, the available time is not specified. Accordingly, an available time H₂ is associated with an amount of received light V₂. Similarly, the available time H_{N} is associated with the amount of received light V_{N}. The available time H_{N} means that the light emitting unit 131 and the light receiving unit 132 need to be replaced. That is, the available time H_{N} means that the sheet detection unit 13 needs to be replaced.

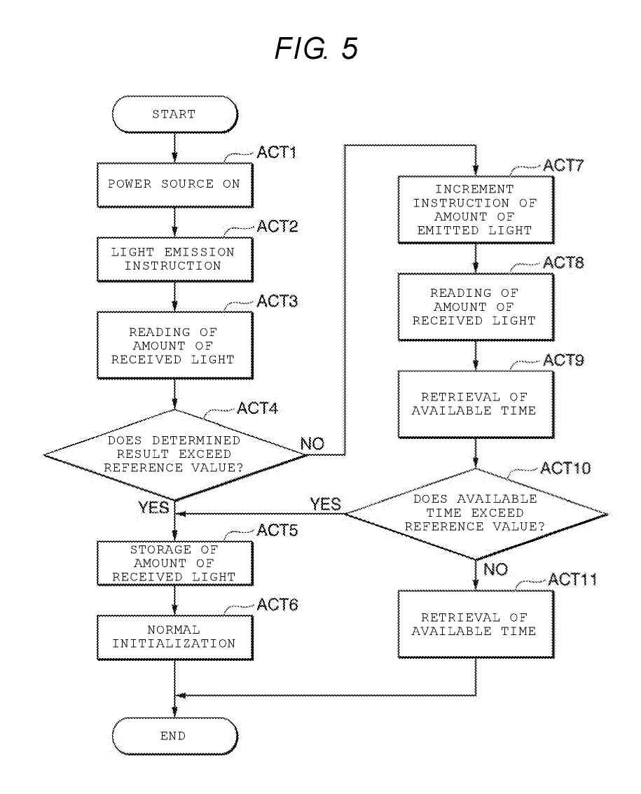

Next, with reference to FIG. 5, an operation of the sheet post-processing apparatus 1 illustrated in FIG. 2 will be described. FIG. 5 is a flowchart illustrating an example sequence of operations of the sheet post-processing apparatus 1 illustrated in FIG. 2. The sheet post-processing apparatus 1 and the image forming apparatus 100 use a common power source.

First, the control unit 11 detects turning ON of the power source (ACT 1). When the turning ON of the power source is detected, the control unit 11 outputs a light emission instruction so as to perform light emission of the amount of light set by the light amount adjustment unit 12 (ACT 2). When the light emission instruction is received, the light amount adjustment unit 12 adjusts a voltage value or a current value so as to become a voltage value or a current value set at the present time, and outputs the adjusted value to the light emitting unit 131.

Next, the control unit 11 reads a voltage value corresponding to the amount of received light output from the light receiving unit 132 (ACT 3). Accordingly, the control unit 11 determines whether or not the read voltage value exceeds a predetermined reference value, i.e., V₁ (ACT 4). When the determined result exceeds the reference value (ACT 4: YES), the control unit 11 associates the amount of emitted light set at the present time with the read amount of received light (voltage value), and stores the associated result in the storage unit 14 (ACT 5). Accordingly, the control unit 11 performs a normal initialization of the sheet post-processing apparatus 1 (ACT 6), and terminates the process.

Meanwhile, when the determined result does not exceed the reference value (ACT 4: NO), the control unit 11 outputs an instruction for increasing the amount of emitted light with respect to the light amount adjustment unit 12 (ACT 7). The light amount adjustment unit 12 then adjusts a voltage value or a current value to emit light in the amount of emitted light B if the amount of emitted light currently set is the amount of emitted light A. However, if the amount of emitted light currently set is emitted light B, the current state is maintained.

Next, the control unit 11 reads the amount of received light (voltage value) output from the light receiving unit 132 (ACT 8). Accordingly, the control unit 11 retrieves an available time with reference to the available time table (ACT 9). At this time, the control unit 11 calculates the available time by linear interpolation, when the read amount of received light is not in the available time table. That is, when the amount of received light is the amount of received light between V₂ and V₃, the available time is calculated by the linear interpolation using values of the available times H₂ and H₃.

Next, the control unit 11 determines whether or not the retrieved available time exceeds a predetermined reference value (ACT 10). For example, the reference value is the amount of received light V₁, for which there is no specified available time. That is, for the amount of received light V₁, the corresponding available time is set as greater than the reference value H₁. When the retrieved available time exceeds the reference value (ACT 10: YES), the control unit 11 associates the amount of emitted light currently set and the read amount of received light (voltage value), and stores the associated result in the storage unit 14 (ACT 5). Accordingly, the control unit 11 performs a normal initialization of the sheet post-processing apparatus 1 (ACT 6), and terminates the process.

Meanwhile, when the retrieved available time does not exceed the reference value (ACT 10: NO), the control unit 11 provides the retrieved available time to the image forming apparatus 100 (ACT 11). The available time may be output to other apparatus (for example, maintenance terminal or the like) using the communication interface (not shown). Then, the control unit 11 terminates the process.

When the available time is provided, the image forming apparatus 100 may display the available time on the display 110. In addition, a time duration in which the available time is displayed on the display 110 may be limited to the case of performing maintenance. In addition, when the available time is H_{N}, a replacement time for replacing the sheet detection unit 13 may be displayed on the display 110.

In addition, when maintenance of the sheet post-processing apparatus 1 is performed, information stored in the light emission and light reception table may be displayed on the display 110.

In addition, the number of failure occurrences of sheet jam or the like in the sheet post-processing apparatus 1 is associated with the information of the table such that the associated result may be stored in the light emission and light reception table. According to the configuration, it is possible to associate the amount of received light and the number of failure occurrences. Therefore, it is possible to determine a time for replacement of the sheet detection unit 13 based on information of the light emission and light reception table. For example, when there is a correlation between a specific reduction of the amount of received light and the number of failure occurrences, it is possible to estimate with a high probability that the sheet detection unit 13 has caused the failure occurrence.

In addition, an example in which a process illustrated in FIG. 5 is performed when the power source is turned ON is described. However, the process illustrated in FIG. 5 is not performed in an apparatus of which the power source is turned OFF. Therefore, the process illustrated in FIG. 5 may be performed whenever a predetermined time elapses.

In the above description, an example in which the deterioration of the light emitting unit 131 and the light receiving unit 132 configuring the sheet detection unit 13 is detected is described. However, the sensor deterioration detection method according to the embodiment can be applied to detect deterioration of another detection unit.

As described above, when the amount of received light does not exceed a reference value, since the amount of emitted light increases, it is possible to prevent erroneous detection in the sheet detection unit 13. In addition, since the amount of received light is stored, when maintenance is performed, it is possible to confirm that the deterioration has occured in the sheet detection unit 13. In addition, since the available time is displayed, it is possible to check a time for replacement of the sheet detection unit 13 in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A sheet post-processing apparatus comprising:
a sensor;
a detection unit configured to detect a deterioration of the sensor based on an output value of the sensor;
a retrieval unit configured to, when the deterioration of the sensor is detected, retrieve an available time indicating a future available time of the sensor, the retrieved available time corresponding to the output value of the sensor; and
an output unit that outputs the retrieved available time.

2. The apparatus according to claim 1, further comprising:
a storage unit that stores an available time table in which output values of the sensor and available times are associated with each other in advance,
wherein the retrieval unit obtains the available time from the available time table.

3. The apparatus according to claim 1, wherein the output unit outputs the available time after a predetermined time elapses.

4. The apparatus according to claim 1, further comprising:
a storage unit that stores the output value of the sensor,
wherein the output unit outputs the output value of the sensor stored in the storage unit.

5. The apparatus according to claim 4, wherein:
the storage unit stores a number of failure occurrences in association with the corresponding output value of the sensor, and
the output unit outputs the number of failure occurrences in association with the corresponding output value.

6. The apparatus according to claim 1, wherein the sensor includes:
a light emitting unit that emits light, and
a light receiving unit that receives the light and the output value of the sensor corresponds to an amount of the received light.

7. The apparatus according to claim 6, further comprising:
a light amount adjustment unit that increases an amount of emitted light of the light emitting unit when an output value of the light receiving unit is less than a predetermined reference value.

8. The apparatus according to claim 6, wherein the sensor performs sheet detection by detecting that the light from the light emitting unit is blocked from being received in the light receiving unit by a sheet.

9. A sheet post-processing apparatus comprising:
a sensor; and
a control unit configured to:
detect a deterioration of the sensor based on an output value of the sensor,
when the deterioration of the sensor is detected, retrieve an available time indicating a future available time of the sensor, the retrieved available time corresponding to the output value of the sensor, and
output the retrieved available time.

10. The apparatus according to claim 9, further comprising:
a storage unit that stores an available time table in which output values of the sensor and available times are associated with each other in advance,
wherein the control unit obtains the available time from the available time table.

11. The apparatus according to claim 9, wherein the control unit outputs the available time after a predetermined time elapses.

12. The apparatus according to claim 9, further comprising:
a storage unit that stores the output value of the sensor,
wherein the control unit outputs the output value of the sensor stored in the storage unit.

13. The apparatus according to claim 12, wherein:
the storage unit stores a number of failure occurrences in association with the corresponding output value of the sensor, and
the control unit outputs the number of failure occurrences in association with the corresponding output value.

14. The apparatus according to claim 9, wherein the sensor includes:
a light emitting unit that emits light, and
a light receiving unit that receives the light and the output value of the sensor corresponds to an amount of the received light.

15. The apparatus according to claim 14, wherein the control unit determines a sheet is present at the sensor location when the light from the light emitting unit is not received in the light receiving unit.

16. A sensor available time determination method comprising the steps of:
detecting a deterioration state of a sensor based on an output value of the sensor;
retrieving an available time indicating a future available time of the sensor, the retrieved available time corresponding to the output value of the sensor; and
outputting the retrieved available time.

17. The method according to claim 16, further comprising the step of:
storing an available time table in which output values of the sensor and available times are associated with each other in advance,
wherein the available time is retrieved from the available time table.

18. The method according to claim 16, further comprising the step of:
storing the output value of the sensor; and
outputting the stored output value of the sensor during a maintenance operation.

19. The method according to claim 16, further comprising the step of:
increasing an amount of emitted light of a light emitting unit of the sensor when an output value of light receiving unit of the sensor is less than a predetermined reference value.

20. The method according to claim 16, further comprising the step of:
detecting a sheet before expiration of the available time by detecting that the light from the light emitting unit is blocked from being received in the light receiving unit by a sheet.
